(19) United States
(12) Patent Application Publication
(10) Pub. No.: US 2015/0332014 A1
(43) Pub. Date: Nov. 19, 2015

(54) DISEASE ANALYSIS APPARATUS, DISEASE ANALYSIS METHOD, AND COMPUTER READABLE MEDIUM

(71) Applicant: NIHON KOHDEN CORPORATION, Tokyo (JP)

(72) Inventors: Norihito Konno, Tokyo (JP); Makoto Hajiri, Tokyo (JP)

(21) Appl. No.: 14/703,334

(22) Filed: May 4, 2015

(30) Foreign Application Priority Data
May 15, 2014 (JP) 2014-101086

(51) Int. Cl. G06F 19/00

(52) U.S. Cl. CPC G06F 19/3437

(57) ABSTRACT

A disease analysis apparatus includes an information acquisition unit that acquires disease occurrence information indicating a disease occurrence status and at least one of environmental factors and biological statistical information, and a model generation unit that generates a disease model that represents a relationship between the disease occurrence status and a change in an attribute value included in at least one of the environmental factors and the biological statistical information, based on the information acquired by the information acquisition unit.

### CROSS REFERENCE TO RELATED APPLICATION

This application is based on Japanese Patent Applications No. 2014-101086 filed on May 15, 2014, the contents of which are incorporated herein by reference.

### BACKGROUND

The presently disclosed subject matter relates to a disease analysis apparatus, a disease analysis method, and a computer readable medium.

Recently, networking of medical devices has been progressing. Accordingly, it has been possible to statistically manage biological information measured by each medical device, through computers (preferably, servers) on networks. It has also been possible to manage information (temperature, humidity and sound information) acquired from various sensors, through such computers. In addition to this, the calculation functions of computers have been advanced day by day. Accordingly, it has been possible to handle so-called big data through computers.

In such an environment, a technology of predicting diseases has been developed from the change in environmental status or the trend in epidemic diseases. JP-A-2008-165716 discloses a disease management apparatus that predicts the occurrence of disease based on information of environmental changes or epidemic diseases and informs people having a disease occurrence risk of the prediction result.

The disease management apparatus predicts the occurrence of disease by substituting acquired environmental factors into a disease prediction table (FIG. 2 of JP-A-2008-165716).

In JP-A-2008-165716, it is thought that the above-described prediction table is defined in advance. In other words, JP-A-2008-165716 neither suggests nor teaches modeling the relationship between the environmental factors and the occurrence of disease.

Generally, the relationship between the environmental factors and the occurrence of disease is not often clear. Specifically, a model representing the relationship between “the value of the environmental factors (temperature, humidity, noise level, etc.) and the degree of risk of disease” is not clear. This is similarly applied to the relationship between the biological information of a subject and the occurrence of disease. Specifically, a model representing the relationship between “the value of biological information (body temperature, blood pressure, anamnesis, etc.) and the degree of risk of disease” is not clear. By creating such models, a disease occurrence status can be grasped and the occurrence of diseases can be predicted accurately.

Thus, a primary object of the presently disclosed subject matter is to provide an apparatus, a method and a computer readable medium, which are capable of modeling the relationship between the occurrence of disease and environmental factors or biological statistical information.

### SUMMARY

(1) According to an aspect of the presently disclosed subject matter, a disease analysis apparatus includes an information acquisition unit that acquires disease occurrence information indicating a disease occurrence status and at least one of the environmental factors and biological statistical information, and a model generation unit that generates a disease model that represents a relationship between the disease occurrence status and a change in an attribute value included in at least one of the environmental factors and the biological statistical information, based on the information acquired by the information acquisition unit.

### BRIEF DESCRIPTION OF DRAWINGS

FIG. 1 is a block diagram showing a configuration of a disease analysis apparatus 1 according to a first embodiment.

FIGS. 2A to 2C are views showing an example of data on environmental factors, biological statistical information and disease occurrence information acquired by an information acquisition unit 11 according to the first embodiment.

FIG. 3 is a view showing a disease model displayed on a display unit 14 according to the first embodiment.

FIG. 4 is a view showing a disease model (graph) displayed on the display unit 14 according to the first embodiment.

FIG. 5 is a view showing a disease model (graph) displayed on the display unit 14 according to the first embodiment.

FIG. 6 is a view showing a disease model displayed on the display unit 14 according to the first embodiment.

FIG. 7 is a view showing a disease model displayed on the display unit 14 according to the first embodiment.

FIG. 8 is a view showing a correlation model (disease model) generated by a model generation unit 12 according to the first embodiment.

FIG. 9 is a view showing a correlation model (disease model) generated by the model generation unit 12 according to the first embodiment.

FIG. 10 is a view showing a correlation model (disease model) generated by the model generation unit 12 according to the first embodiment.

FIG. 11 is a view showing a correlation model (decision tree) generated by the model generation unit 12 according to the first embodiment.

FIG. 12 is a block diagram showing a configuration of a disease analysis apparatus 2 according to a second embodiment.

FIG. 13 is a view showing an example of a display screen generated by a prediction unit 16 according to the second embodiment.

FIG. 14 is a block diagram showing a configuration of a disease analysis apparatus 3 according to a third embodiment.

### DETAILED DESCRIPTION OF EMBODIMENTS

### First Embodiment

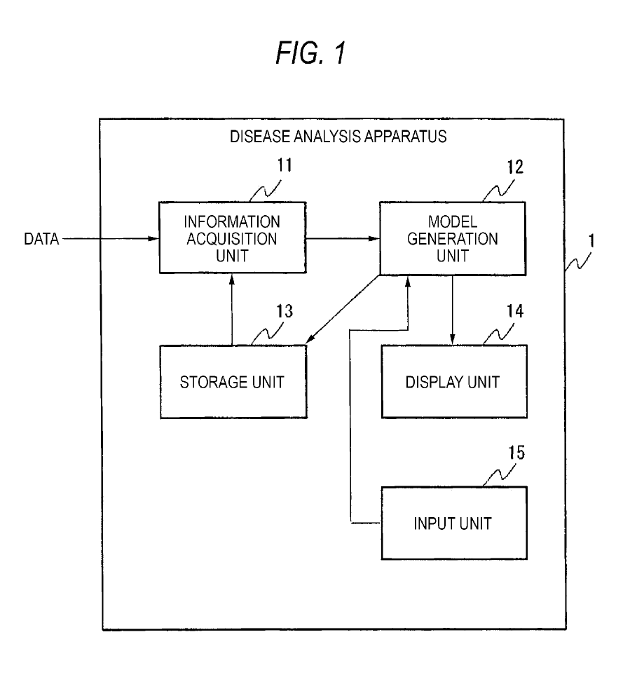

Hereinafter, an illustrative embodiment of the presently disclosed subject matter will be described with reference to the drawings. FIG. 1 is a block diagram showing a configuration of a disease analysis apparatus 1 according to the present embodiment. The disease analysis apparatus 1 includes an information acquisition unit 11, a model generation unit 12, a storage unit 13, a display unit 14, and an input unit 15. Preferably, the disease analysis apparatus 1 is a computer device that has a CPU (Central Processing Unit) and HDD (Hard Disk Drive) and is capable of processing a large amount of data.

The information acquisition unit 11 acquires environmental factors or biological statistical information from various medical devices, sensors, or a server for managing the medical devices or sensors. Alternatively, the information acquisition unit 11 acquires environmental factors or biological statistical information from the storage unit 13 within the disease analysis apparatus 1. Additionally, the information acquisition unit 11 acquires disease occurrence information from a server on a network or the storage unit 13. That is, the information acquisition unit 11 operates not only as a communication unit but also as an interface for reading out various files or database.

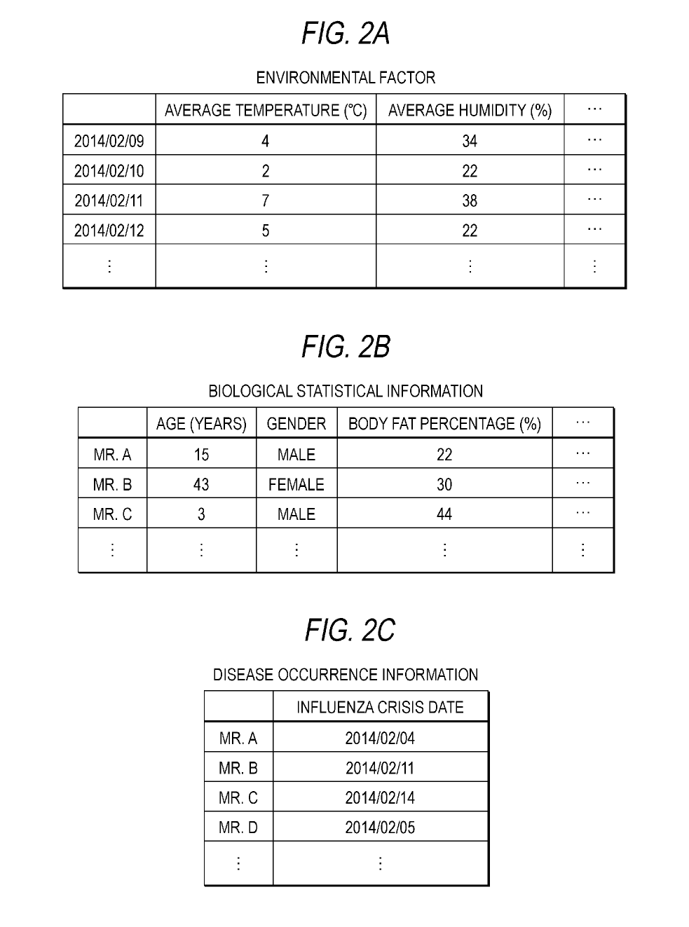

FIGS. 2A to 2C are conceptual diagrams showing an example of a configuration of respective information. FIG. 2A is a view showing an example of environmental factors. The data example includes the average temperature and average humidity of each day. Meanwhile, FIG. 2A only shows an example, and the data may include attribute data (attribute value) of various environmental factors such as illuminance, atmospheric pressure, noise, acceleration and physical location. Further, as shown in FIG. 2A, data may not be managed on a daily basis, but rather may be managed on the basis of a smaller time unit (e.g., on an hourly basis). The environmental factors refer to information of various attributes of any environment surrounding humans.

FIG. 2B is a view showing an example of biological statistical information. The data example includes ages, gender and body fat percentages. Meanwhile, FIG. 2B only shows an example, and the data may include various biometric data (attribute values) such as blood pressure, height, weight, cardiac output, body temperature. The biological statistical information refers to a statistical summary of biological information (blood pressure, height, etc.) for many subjects.

FIG. 2C is a view showing an example of disease occurrence information. The data example exhibits a disease occurrence status of each person. The data example includes an influenza crisis date of each person. Meanwhile, FIG. 2C only shows an example, and the disease to be handled includes disease from a life-threatening disease such as cancer to a transient disease such as cold. Further, the disease to be handled includes not only visceral disease but also chronic lifestyle-related disease such as backache and shoulder discomfort.

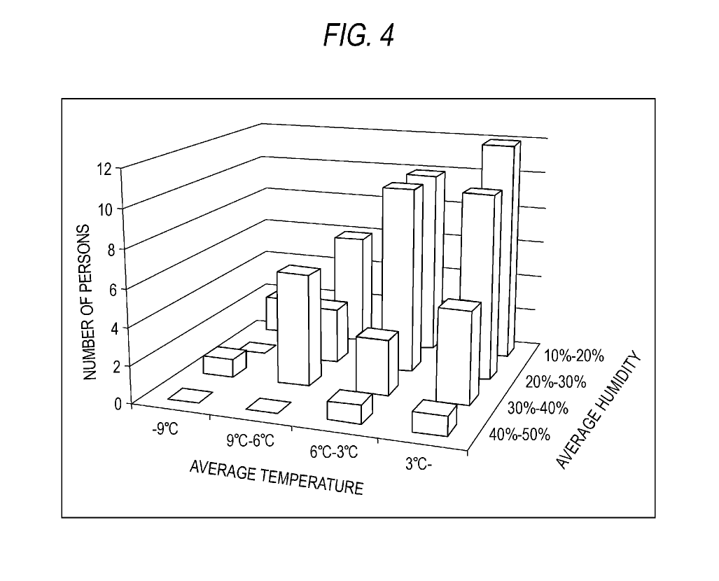

Referring back to FIG. 1, the information acquisition unit 11 supplies the acquired various information (FIGS. 2A to 2C) to the model generation unit 12. The model generation unit 12 generates a disease model representing a disease occurrence status by analyzing the relationship between the disease occurrence information (FIG. 2C) and at least one of the environmental factors (FIG. 2A) and the biological statistical information (FIG. 2B). An example of the disease model will be described later with reference to FIG. 4 or the like. The display unit 14 displays the disease model generated by the model generation unit 12. The display unit 14 is configured by any display device connected to the disease analysis apparatus 1 and a control circuit of the display device, or the like. Meanwhile, in addition to displaying the generated disease model, the model generation unit 12 may store the generated disease model in the storage unit 13.

The input unit 15 receives various inputs from a user. The input unit 15 is a mouse or a keyboard, for example. Meanwhile, the input unit 15 and the display unit 14 may be integrally provided (e.g., a touch screen).

Subsequently, a method of generating the disease model by the model generation unit 12 is described. In the following description, it is assumed that the model generation unit 12 uses various data indicated in FIGS. 2A to 2C to make the disease model. Meanwhile, it is not essential that the model generation unit 12 deals with both the attributes related to the environmental factors and the attributes related to the biological statistical information. In some cases, analysis may be performed by using only one thereof.

The model generation unit 12 respectively calculates the relevance between the disease occurrence status and the attribute value of each attribute (average temperature, average humidity, etc.) included in the environmental factors or the attribute value of each attribute (ages, gender, body fat percentages) included in the biological statistical information. In the present example, the model generation unit 12 calculates the relevance (e.g., correlation coefficient) between each attribute value and the number of occurrence of the disease (influenza).

In the example of FIGS. 2A to 2C, the model generation unit 12 calculates the relevance between the average temperature and the number of occurrence of influenza. For example, the model generation unit 12 calculates the number of crisis of influenza in the average temperature of 9° C. or more, the number of crisis of influenza in the average temperature of 9° C. to 6° C., the number of crisis of influenza in the average temperature of 6° C. to 3° C., and the number of crisis of influenza in the average temperature less than 3° C., respectively.

Similarly, the model generation unit 12 calculates the relevance between the average humidity and influenza. For example, the model generation unit 12 calculates the number of crisis of influenza in the average humidity of 10% to 20%. Similarly, the model generation unit 12 calculates the number of crisis of influenza in the average humidity of 20% to 30%, in the average humidity of 30% to 40% and in the average humidity of 40% or more, respectively.

In the same manner, the model generation unit 12 calculates the number of crisis of influenza for each age, the number of crisis of influenza for each gender, and the number of crisis of influenza for each body fat percentage, respectively.

Then, the model generation unit 12 extracts an attribute that is highly related with the occurrence of disease. Here, the highly-related attribute refers to an attribute where the number of occurrence of the disease increases (decreases) with the increase (decrease) of the attribute value when the attribute value can be expressed by a numerical value. The model generation unit 12 extracts the highly-related attribute from all attributes. Generally, a user can intuitively understand a matrix form. Accordingly, the model generation unit 12 extracts approximately two highly-related attributes. Then, the model generation unit 12 generates, as a disease model, a distribution representing the extracted attributes and the number of crisis of disease.

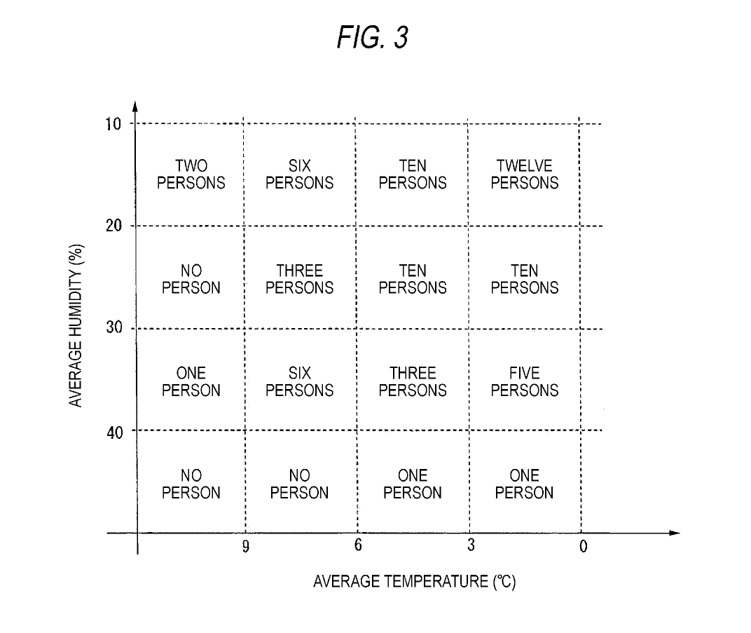

The model generation unit 12 displays the generated disease model on the display unit 14. FIG. 3 is a view showing an example of the disease model displayed on the display unit 14. In FIG. 3, the average temperature and the average humidity are extracted as the attributes that are highly related to the occurrence of disease. By referring to FIG. 3, a user can grasp that the crisis of influenza increases when the average temperature is low and the average humidity is low. For the convenience of description, FIG. 3 shows a disease model for about seventy subjects. However, an actual disease model can be made to deal with a disease model (e.g., a disease model for several million people) for a significant number of subjects.

Further, the model generation unit 12 may display, as a graph, the relationship between the attribute value and the number of occurrence of disease. In this case, the graph contains bar graph, histogram, and so on. FIG. 4 shows an example where the disease model is displayed as a graph. By referring to the graph shown in FIG. 4, a user can grasp that he must be careful of influenza (e.g., he must thoroughly gargle his mouth and wash his hands) in a certain climate condition. Specifically, a user can visually recognize that he must be careful of influenza especially when the average humidity is less than 30% and the average temperature is less than 6° C.

From the information of FIG. 3 or FIG. 4, the relationship between the highly-related attributes and the number of crisis of disease can be grasped, but the relationship between other attributes (ages, etc.) and the crisis of disease (influenza) cannot be grasped. Therefore, the disease analysis apparatus 1 may acquire information of the attribute that a user wants to grasp the relevance and then recreate (reconfigure) the disease model in accordance with the attribute acquired.

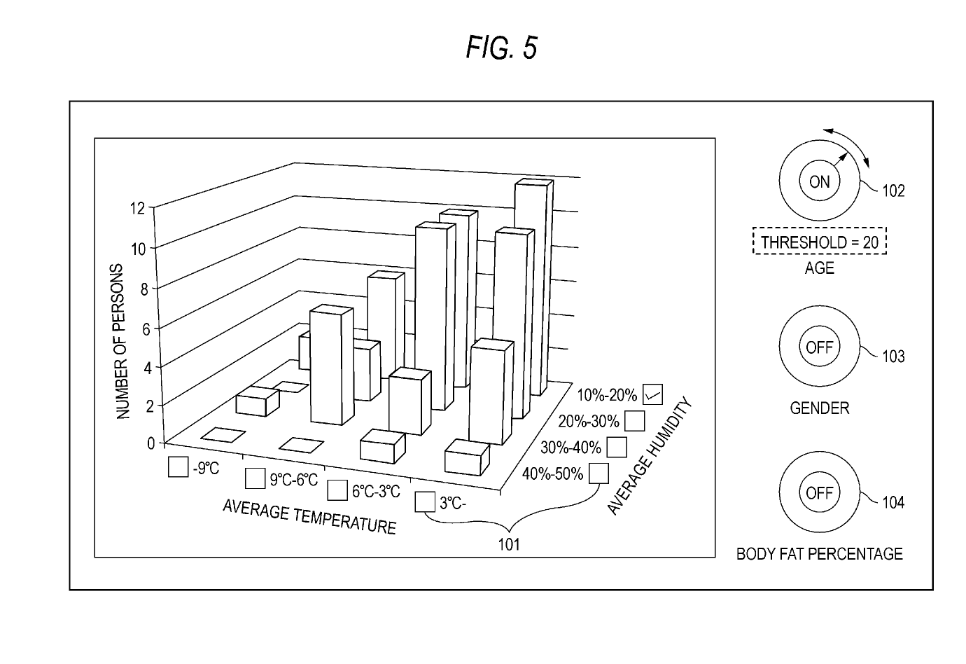

FIG. 5 is a view showing a disease model including various interfaces (e.g., radio box, knob, etc.) that receives a specified attribute from a user. The model generation unit 12 creates and displays the graph shown in FIG. 4. In addition to this, the model generation unit 12 provides a checkbox 101 for selecting a value range of each attribute and knobs 102 to 104 for switching the display ON/OFF of each attribute that is not displayed in the graph. The checkbox 101 or the knobs 102 to 104 are one aspect of an input interface for specifying the attribute or the value range of the attribute value. A user operates the checkbox 101 or the knobs 102 to 104 by the input unit 15 (e.g., a mouse, a keyboard, a touch screen, etc.).

A user switches ON/OFF by clicking a central portion of the knob 102 to 104 corresponding to the attribute that he wants to analyze. Further, in the case of selecting ON, a user specifies how to analyze. In the present example, a user specifies that the disease model is reconfigured depending on whether or not the age is 20 years old or older. That is, a user specifies the attribute and the threshold of the attribute.

Further, of the attributes that a user wants to analyze, a user selects the attribute that is a target upon reconfiguring the disease model, and a value range thereof. In the present example, as a target range upon reconfiguring the disease model, a user specifies only a value range of 10% to 20% for the average humidity.

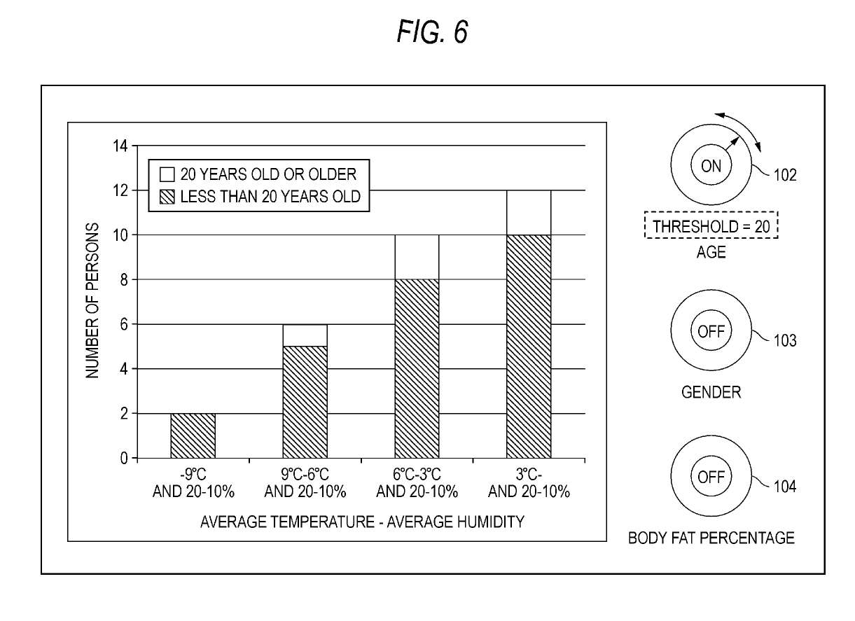

The model generation unit 12 recreates a disease model by calculating the number of crisis of influenza based on the specified attribute and the specified value range. FIG. 6 shows a disease model that is reconfigured according to the specifications shown in FIG. 5. In the example of FIG. 6, the model generation unit 12 creates a disease model that represents details of the distribution shown in FIG. 5, depending on whether or not the age is 20 years old or older. The model generation unit 12 may reconfigure a disease model by counting the number of disease again according to the specified attribute and the specified attribute value.

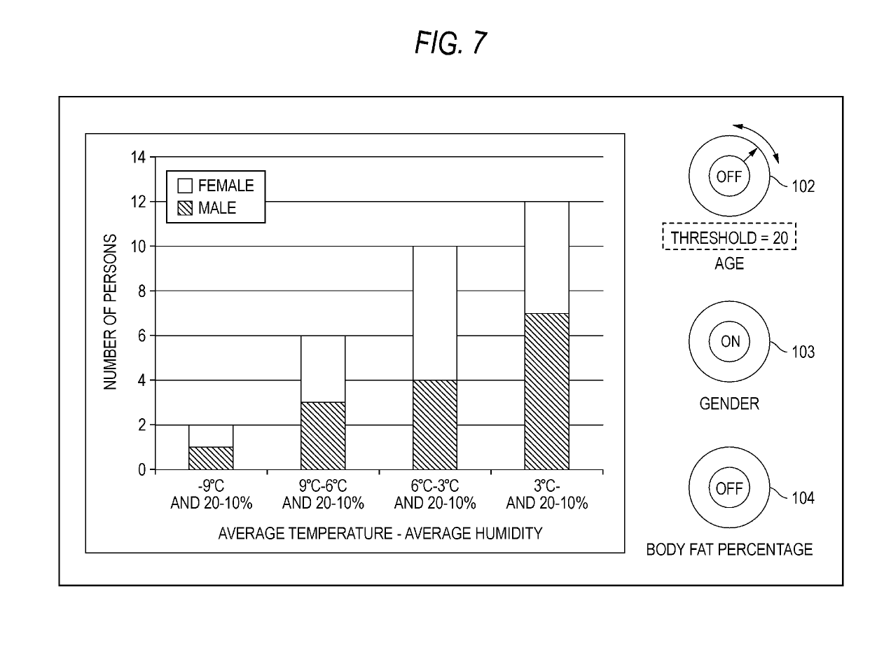

Further, FIG. 7 is a view showing a disease model reconfigured when gender instead of age is selected in the display screen shown in FIG. 5. The model generation unit 12 creates a disease model that is reconfigured so as to represent, as the details for the disease model shown in FIG. 5, whether gender is male or female.

Referring to FIG. 6, the number of crisis is very high when age is less than 20 years old. Therefore, a user can visually recognize that not only the average temperature or the average humidity but also the age has a significant effect on the crisis of influenza. Referring also to FIG. 7, it can be understood that there is little difference in the number of crisis between the male and the female. Therefore, a user can estimate that the gender has no large effect on the crisis of influenza.

As shown in FIG. 6 and FIG. 7, the model generation unit 12 continues to display the input interface (in this case, knobs 102 to 104) also on the display screen of the disease model reconfigured. Then, the model generation unit 12 reconfigures the disease model each time the input interface (knobs 102 to 104) is operated. In this way, a user can recognize the change in the crisis status of disease by changing the attribute value with reference to a graph (disease model).

Meanwhile, the display screens shown in FIG. 3 to FIG. 7 are just an example, and the presently disclosed subject matter is not limited thereto. For example, although FIG. 5 shows a three-dimensional graph having two target attributes, a two-dimensional graph having only one target attribute may be displayed.

Although the model generation unit 12 generates a disease model by extracting the attribute that is highly related with the crisis of disease, the presently disclosed subject matter is not necessarily limited thereto. A disease model having a target attribute that is explicitly selected by a user may be created.

In the above-describe embodiment, the disease model is explained as a graph for each attribute. However, the presently disclosed subject matter is not necessarily limited thereto. Hereinafter, other creation examples of the disease model by the model generation unit 12 will be described.

### Another Creation Example 1

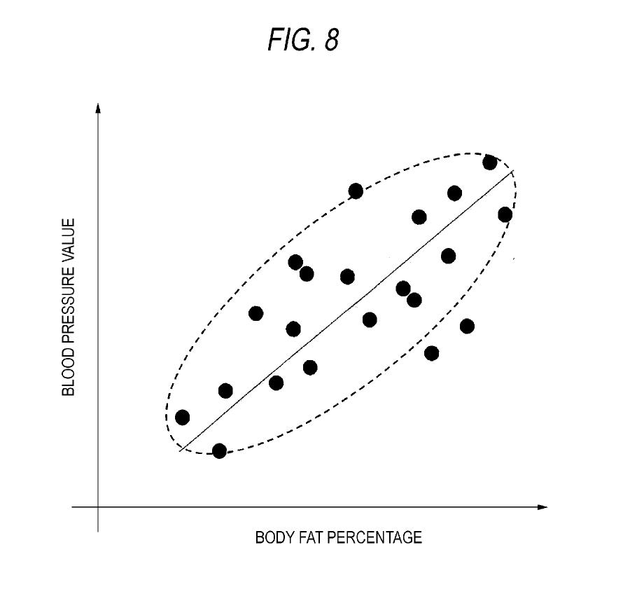

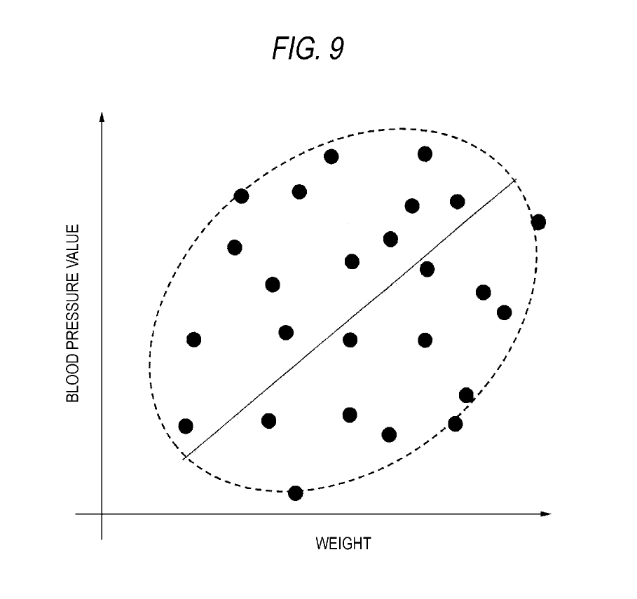

When the degree of disease and the attribute value can be expressed by a numerical value, the model generation unit 12 may create a correlation model where the change in the attribute value and disease are plotted. FIG. 8 shows an example of a correlation model where the relationship between the change (biological statistical information) in the body fat percentage and the high blood pressure (disease) is plotted. Similarly, FIG. 9 shows a correlation model where the relationship between the change (biological statistical information) in weight and the high blood pressure (disease) is plotted. In this way, the model generation unit 12 creates a correlation model as a disease model. Specifically, the model generation unit 12 selects each attribute one by one and plots a point where an attribute value and a value (blood pressure value in the case of FIG. 8 and FIG. 9) of disease intersect with each other. Then, the model generation unit 12 performs calculation or the like of a correlation coefficient by using the plotted view.

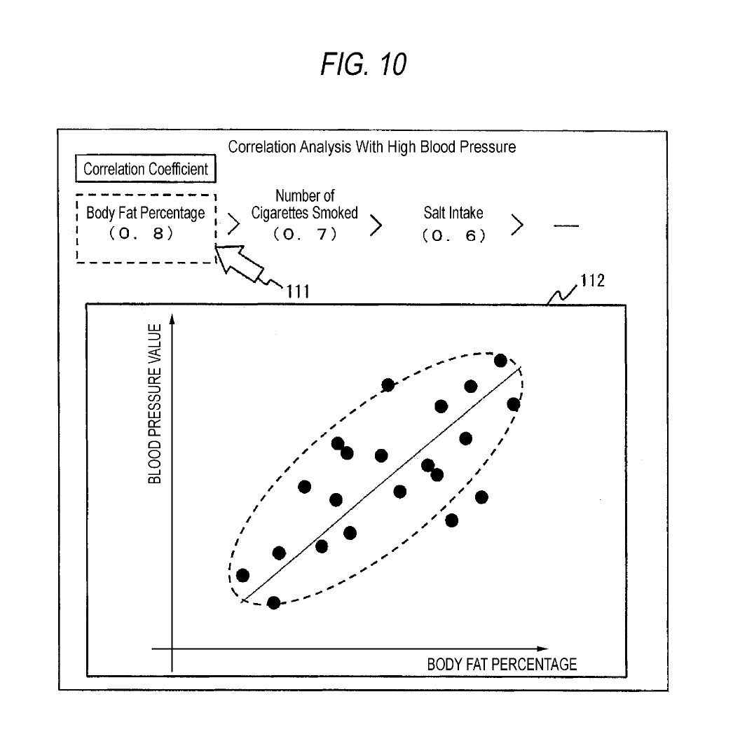

The model generation unit 12 extracts an attribute where the correlation coefficient is high. Then, the model generation unit 12 displays a display screen representing the calculated correlation coefficient or the correlation model on the display unit 14. FIG. 10 shows an example of a user interface displayed on the display unit 14. On the display screen, a correlation coefficient between each attribute calculated and the high blood pressure is displayed. The example of FIG. 10 represents that the correlation is high in order of the body fat percentage, the number of cigarettes smoked and the salt intake. A user selects an attribute that he wants to display, by operating a mouse pointer 111 of a mouse by hand. A correlation graph of the attribute selected is displayed on a display area 112.

A user can grasp the attribute that is highly related with a target disease (high blood pressure in the present example) with reference to the display screen. For example, a user can recognize that an attribute which has not been focused up to now is highly related with the occurrence of disease. Meanwhile, the display screen is not limited to one shown in FIG. 10. For example, correlation graphs of all attributes may be displayed on one screen.

### Another Creation Example 2

The model generation unit 12 may create, as a disease model, a decision tree using respective attributes. Hereinafter, in order to explain an example of creating a decision tree, an asthma crisis model is described as an example. The model generation unit 12 creates a decision tree by using a general creation algorithm (e.g., ID3 algorithm). Here, the model generation unit 12 may calculate an average information (entropy) for each attribute, and only the attribute where the average amount of information is high may be used upon creating the decision tree.

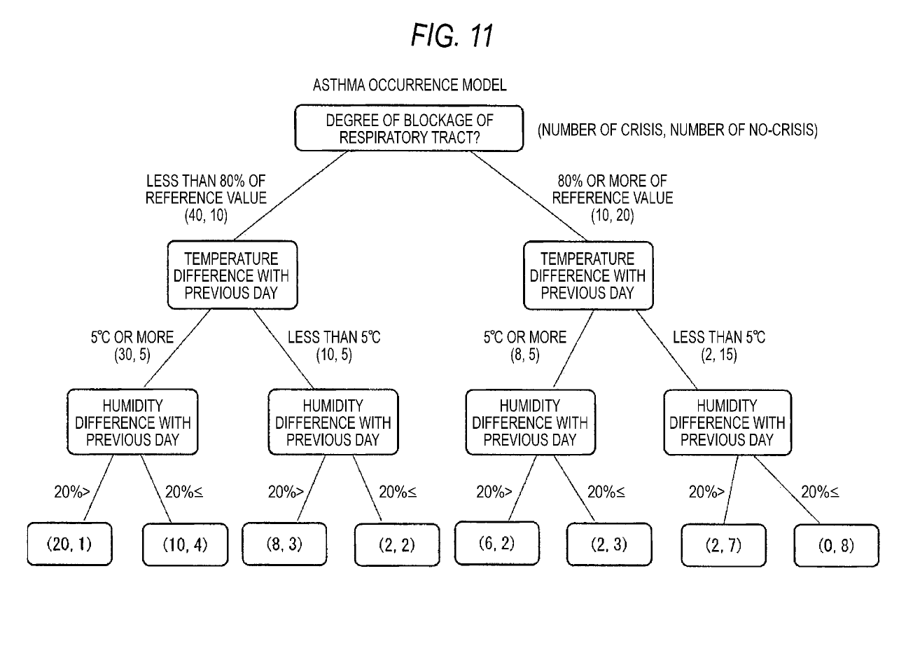

FIG. 11 is a view showing an example of the decision tree created by the model generation unit 12. The example of FIG. 11 creates a decision tree related to the crisis probability of asthma. In the present example, the degree (peak flow value) of blockage of respiratory tract has the highest average amount of information. Accordingly, the degree of blockage of respiratory tract is used as a first question. This example represents that the peak flow values of fifty of eighty subjects are less than 80% and the crisis of asthma occurs in forty of the fifty subjects. The threshold (e.g., whether or not the degree of blockage of respiratory tract is equal to or greater than 80% of a reference value) of the attribute that is used in the question may be selected so as to have the highest average amount of information by a try-and-error method, or may be explicitly specified by a user.

The model generation unit 12 presents the created decision tree to a user via the display unit 14. A user can grasp that the crisis probability of disease is high at a certain condition by checking the decision tree (FIG. 11). From the example of FIG. 11, a user can recognize that the crisis probability of disease is high when the peak flow value is small and the temperature difference and humidity difference with the previous day is large.

(Effect of Disease Analysis Apparatus 1)

Subsequently, effects of the disease analysis apparatus 1 according to the present embodiment will be described. The model generation unit 12 generates a disease model by analyzing the disease occurrence information and at least one of the environmental factors (e.g., average temperature, average humidity, etc.) and the biological statistical information (e.g., gender, body fat percentages, etc.). Here, the generation of the disease model is executed by the analysis of the relationship between the change in the attribute value and the number of occurrence of disease, for example. That is, the model generation unit 12 generates a disease model where the occurrence status of disease can be grasped from raw data such as the environmental factors, the biological statistical information and the disease occurrence information. A user can deeply understand disease with reference to this disease model. Therefore, a user can easily consider an advanced prevention or countermeasure.

The disease model is a graph as shown in FIG. 4, for example. The graph visually indicates the change in the attribute value and the crisis risk of disease. Therefore, by referring to this graph, a user can recognize that the occurrence risk of disease is high when the attribute value of certain attribute (e.g., average temperature) is in a certain state.

Further, the model generation unit 12 calculates the relevance (e.g., correlation coefficient) between each attribute and the number of occurrence of disease when generating the graph. Then, the model generation unit 12 uses, as an axis of the graph, an attribute where the relevance is relatively high (in other words, a high level). In this way, the graph represents the relationship between the occurrence of disease and the attribute that is most relevant to the crisis of disease. By referring to this graph, a user can visually recognize that a certain attribute is highly related with the occurrence of disease and the risk of crisis of disease is high at a certain range of the attribute value.

Further, the model generation unit 12 reconfigures the disease model in response to an input of a user. As a specific example, the model generation unit 12 reconfigures the disease model by using the value range or the type of the attribute selected in an input screen of FIG. 5. In this way, a user can grasp the relationship between the occurrence of disease and the change in the attribute value of the attribute that is explicitly selected. For example, in the examples of FIG. 6 and FIG. 7, a user can recognize that age is relevant to the crisis of influenza but gender is less relevant thereto. In the above description, an example where the model generation unit 12 reconfigures the graph has been described. However, the model generation unit 12 may reconfigure the correlation model or the decision tree.

Further, the model generation unit 12 may represent the disease model reconfigured, as a graph as shown in FIG. 6 or FIG. 7. In this way, a user can easily understand how much the risk of occurrence of disease increases with the changes of the threshold (value specified by the knobs 102 to 104 in FIG. 6 or FIG. 7).

### Second Embodiment

Subsequently, a disease analysis apparatus 2 according to a second embodiment of the presently disclosed subject matter will be described. The disease analysis apparatus 2 according to the present embodiment has a function of predicting how large the risk of crisis of disease is in the case of the conditions (inspection conditions) inputted. Hereinafter, the disease analysis apparatus 2 according to the present embodiment will be described focusing on the differences from the first embodiment. In the following drawings, the processing parts denoted by the same name and reference numeral as the first embodiment are assumed to perform the same operation as the first embodiment, unless specifically described. This is similarly applied to a third embodiment.

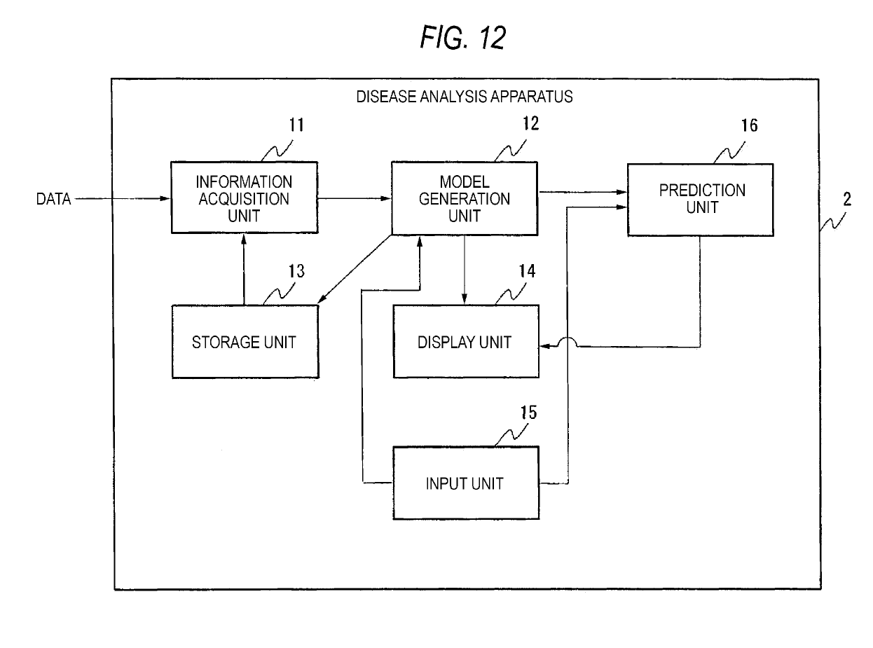

FIG. 12 is a block diagram showing a configuration of the disease analysis apparatus 2 according to the present embodiment. The disease analysis apparatus 2 further includes a prediction unit 16, in addition to the configurations of the disease analysis apparatus 1 shown in FIG. 1. A user inputs the inspection conditions through the input unit 15. Here, the inspection conditions refer to conditions that he wants to inspect the occurrence probability of disease. A user inputs the inspection conditions by specifying the attribute value of the biological statistical information or any environmental factors. For example, the inspection conditions correspond to conditions that “age is less than 12 years old,” “body fat percentage is equal to or greater than 30%,” “average temperature is less than 10° C.,” and “average temperature is less than 10° C. and average temperature difference with the previous day is equal to or greater than 3° C.” In the following description, a predicting method using the disease model of FIG. 3 or FIG. 4 as a target will be described.

The disease model generated by the model generation unit 12 and the inspection conditions are inputted to the prediction unit 16. Preferably, the model generation unit 12 reconfigures the disease model in accordance with the inspection conditions to be inputted. For example, when a condition of “average temperature is less than 6° C. and average humidity is less than 30%” is inputted as the inspection conditions, the model generation unit 12 generates the disease model (i.e., model of FIG. 3) that has the average temperature and the average humidity as a target.

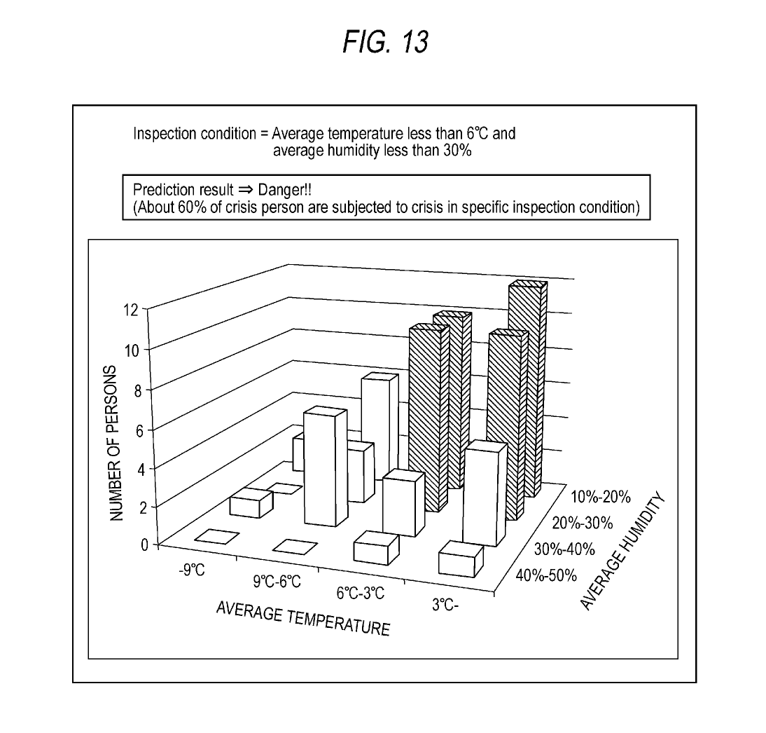

The prediction unit 16 highlights and displays, on the display unit 15, the location of the inspection conditions in the disease model. At this time, the prediction unit 16 also displays a predictive indicator representing how much inspection conditions correspond to conditions that cause disease. FIG. 13 shows an example of a display screen generated by the prediction unit 16.

As shown in FIG. 3, when the average temperature is less than 6° C. and the average humidity is less than 30%, the crisis occurs in about 60% ((10+10+10+12)/70) of the influenza crisis people. The prediction unit 16 predicts that the crisis probability of influenza is very high in an inspection condition where “the average temperature is less than 6° C. and the average humidity is less than 30%.” Therefore, the prediction unit 16 displays a warning message (danger!! (about 60% of the crisis person is subjected to the crisis in a specified inspection condition)) together with the disease model, as shown. Further, the prediction unit 16 highlights and displays the corresponding locations of the inspection conditions in the disease model, as shown.

When tomorrow's weather condition is inputted as the inspection conditions, a user can grasp that the crisis probability of influenza of tomorrow is very high. Further, from (the axis of) the graph of FIG. 13, a user can grasp that the crisis of influenza is relevant to the average temperature or the average humidity. Accordingly, a user can take precautions of increasing the humidity by using a humidifier, or warming a room.

In this way, the disease analysis apparatus 2 according to the present embodiment can predict the occurrence of disease based on the disease model generated by the model generation unit 12. By referring to the occurrence prediction of disease, a user can grasp the occurrence risk of disease in the target inspection condition. When the occurrence risk of disease is high, a user takes various precautions (e.g., of refraining from going out, of using a dehumidifier, of using a humidifier, of actively using the heating of room, of taking medicine on blood pressure, of refraining from eating meals with a lot of salt, etc.). As a result, it is possible to prevent the occurrence of disease.

### Third Embodiment

A disease analysis apparatus 3 according to the present embodiment is characterized by acquiring, from a sensor, at least a part of the inspection conditions inputted to the prediction unit 16. The disease analysis apparatus 3 according to the present embodiment will be described focusing on the differences from the disease analysis apparatus 2 of the second embodiment.

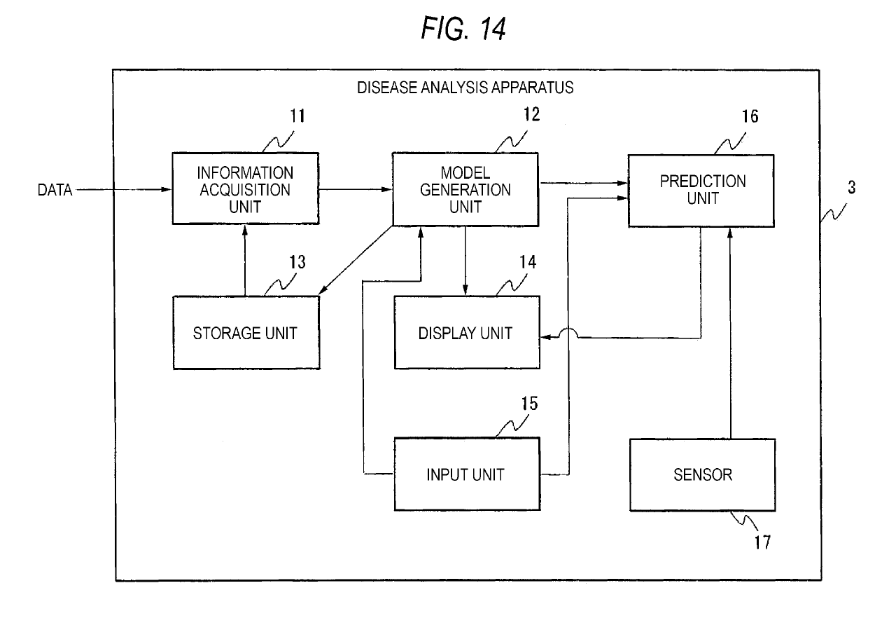

FIG. 14 is a block diagram showing a configuration of the disease analysis apparatus 3 according to the present embodiment. As shown, the disease analysis apparatus 3 further includes a sensor 17, in addition to the configurations shown in FIG. 12. The sensor 17 is adapted to acquire any one of the environmental factors or the biological statistical information (blood pressure, heart rate or the like of a predetermined user). The sensor 17 may acquire the environmental factors, for example, and may be a thermometer, a hygrometer, a barometer, a sound level meter, an acceleration sensor, or the like. Further, the sensor 17 may be configured as a part of a biological information monitor or the like, for example. In this case, the sensor 17 may acquire a body temperature, a blood pressure, a pulse rate, SpO2, a cardiac output, respiration, etc. Meanwhile, the sensor 17 may be configured separately from the disease analysis apparatus 1. For example, the sensor 17 may be mounted as a part of the biological information monitor that is connected to the disease analysis apparatus 1 via a network.

The prediction unit 16 automatically captures, as the inspection conditions, various data acquired by the sensor 17. Here, the timing when the prediction unit 16 captures the data may be a constant time interval or may be changed in a direction in which the biological information (blood pressure, heart rate or the like of a predetermined user) acquired by the sensor 17 is deteriorated. In the case where the prediction is performed at the timing when the biological information is deteriorated, the disease analysis apparatus 1 may inform the prediction result that the occurrence probability of disease is high. For example, the disease analysis apparatus 1 informs the prediction result by voice or informs the prediction result to a pre-registered notification destination (e.g., a physician in charge of the patient with the sensor 17, or the like) by e-mail.

In this way, the prediction unit 16 automatically captures the data acquired by the sensor 17, so that a user is no longer required to explicitly input the inspection conditions. Further, the prediction unit 16 informs the risk by automatically performing prediction according to the change in the biological information (blood pressure, heart rate or the like of a predetermined user). As a result, it is possible to prevent the crisis (e.g., crisis prone to cause sudden change, such as myocardial infarction) of serious disease.

Hereinabove, the invention made by the present inventor has been concretely described with reference to the illustrative embodiments. However, the present invention is not limited to the illustrative embodiments. Of course, the present invention can be variously modified without departing from the gist of the invention.

In the above description, influenza or the like has been explained as an example. However, the presently disclosed subject matter is not limited thereto but can be applied to various diseases. For example, clear criteria for dysphagia or the like are not provided at present. The disease analysis apparatus 1 creates a disease model for dysphagia by using the method described above. By analyzing environmental factors or biological information for many patients, a user can consider a prophylactic method for preventing dysphagia and rehabilitation when dysphagia occurs.

Meanwhile, each processing of the information acquisition unit 11, the model generation unit 12 and the prediction unit 16, which are described above, can be realized as a program that operates in the disease analysis apparatus 1. The program can be stored using various types of non-transitory computer readable medium and be supplied to a computer. The non-transitory computer readable medium includes various types of tangible storage medium. As an example, the non-transitory computer readable medium includes a magnetic recording medium (e.g., a flexible disk, a magnetic tape, a hard disk drive), a magneto-optical recording medium (e.g., a magneto-optical disk), CD-ROM (Read Only Memory), CD-R, CD-R/W, a semiconductor memory (e.g., a mask ROM, a PROM (Programmable ROM), an EPROM (Erasable PROM), a flash ROM, a RAM (random access memory)). Further, the program may be supplied to a computer by various types of transitory computer readable medium. As an example, the transitory computer readable medium includes an electrical signal, an optical signal and an electromagnetic wave. The transitory computer readable medium can supply the program to a computer through a wired communication path such as a wire and an optical fiber, or a wireless communication path. Meanwhile, the storage unit 13 may configure all or a part of the above-described non-transitory computer readable medium.

According to an aspect of the presently disclosed subject matter, the model generating unit generates a disease model by analyzing disease occurrence information and at least one of the environmental factors (e.g., average temperature and average humidity, etc.) and biological statistical information (e.g., gender, body fat percentages, etc.). That is, the model generating unit generates a disease model for grasping out a disease occurrence status from raw data such as the environmental factors, the biological statistical information and the disease occurrence information. By referring to the disease model, a user can deeply understand the disease and consider an advanced prevention or countermeasures.

It is provided that a disease analysis apparatus, a disease analysis method and a computer readable medium, which are capable of modeling the relationship between the occurrence of disease and environmental factors or biological statistical information.

What is claimed is:

1. A disease analysis apparatus comprising:
an information acquisition unit that acquires disease occurrence information indicating a disease occurrence status and at least one of the environmental factors and biological statistical information; and
a model generation unit that generates a disease model that represents a relationship between the disease occurrence status and a change in an attribute value included in at least one of the environmental factors and the biological statistical information, based on the information acquired by the information acquisition unit.

2. The disease analysis apparatus according to claim 1, further comprising a display unit that displays the disease model generated by the model generation unit.

3. The disease analysis apparatus according to claim 2, wherein the model generation unit generates, as the disease model, a graph that includes, as an axis, each attribute constituting the environmental factors or the biological statistical information and represents the number of occurrence of disease.

4. The disease analysis apparatus according to claim 3, wherein the model generation unit calculates relevance between each attribute constituting the environmental factors or the biological statistical information and the number of occurrence of disease, and uses, as the axis of the graph, the attribute where the relevance is relatively high.

5. The disease analysis apparatus according to claim 1, further comprising an input unit that receives an attribute value of the attribute constituting the environmental factors or the biological statistical information,
wherein the model generation unit is adapted to reconfigure the disease model by using the attribute value inputted by the input unit as a threshold.

6. The disease analysis apparatus according to claim 2, further comprising an input unit that receives an attribute value of the attribute constituting the environmental factors or the biological statistical information,
wherein the model generation unit is adapted to reconfigure the disease model by using the attribute value inputted by the input unit as a threshold.

7. The disease analysis apparatus according to claim 6, wherein the model generation unit displays an input interface that is operated by the input unit together with the disease model on the display unit, and the model generation unit reconfigures the disease model in response to the operation of the input interface while displaying the disease model.

8. The disease analysis apparatus according to claim 1, further comprising a prediction unit that predicts the occurrence of disease under an inspection condition by substituting the inspection condition into the disease model.

9. The disease analysis apparatus according to claim 8, further comprising a sensor that captures all or a part of the attribute value constituting the inspection condition.

10. A disease analysis method comprising:
acquiring disease occurrence information indicating a disease occurrence status and at least one of the environmental factors and biological statistical information; and
generating a disease model that represents the relationship between the disease occurrence status and the change in an attribute value included in at least one of the environmental factors and the biological statistical information, based on the information acquired in the information acquisition step.

11. A computer readable medium storing a program for causing a computer to execute a process for analyzing disease, the process comprising:
acquiring disease occurrence information indicating a disease occurrence status and at least one of the environmental factors and biological statistical information; and
generating a disease model that represents the relationship between the disease occurrence status and the change in an attribute value included in at least one of the environmental factors and the biological statistical information, based on the information acquired in the information acquisition step.
